(19) United States
(12) Patent Application Publication
(10) Pub. No.: US 2026/0100018 A1
(43) Pub. Date: Apr. 9, 2026

(54) Micro-operation-based object segmentation method based on improved Otsu and edge operators

(71) Applicant: Harbin University of Science and Technology, Harbin City (CN)

(72) Inventors: Dongjie LI, Harbin City (CN); Fuyue ZHANG, Harbin City (CN); Yu ZHANG, Harbin City (CN); Yu LIANG, Harbin City (CN); Donghao XU, Harbin City (CN); Liu YANG, Harbin City (CN); Xueying WANG, Harbin City (CN)

(73) Assignee: Harbin University of Science and Technology, Harbin City, HL (CN)

(21) Appl. No.: 19/415,661

(22) Filed: Dec. 10, 2025

(30) Foreign Application Priority Data
Dec. 19, 2024 (CN) CN202411880742.8

(51) Int. Cl. G06V 10/30; G06V 10/26; G06V 10/34

(52) U.S. Cl. CPC G06V 10/30; G06V 10/26; G06V 10/34

(57) ABSTRACT

This invention presents an enhanced micro-operation target segmentation method utilizing improved Otsu and edge operators, addressing the limitations of conventional techniques in microscopic visual environments. The proposed approach effectively mitigates accuracy constraints caused by image noise and shadow effects from uneven illumination. The methodology comprises three key phases: Applying an optimized bilateral filtering algorithm to perform noise reduction on grayscale images, producing denoised images; Segmenting micro-operation targets using the refined Otsu algorithm on these denoised images to obtain initial segmentation results; Directly applying the final segmentation result when meeting predefined criteria, or conducting iterative segmentation through the enhanced edge operator and Otsu algorithm if necessary. This innovative method demonstrates exceptional performance in micro-operation target detection applications

### TECHNICAL FIELD

The present invention belongs to the technical field of micro-operation target segmentation under microscopic vision, and specifically relates to a micro-operation target segmentation method based on improved Otsu and edge operators.

### BACKGROUND ART

As micro-manipulation tasks grow increasingly complex, the demands for precision and accuracy have become more stringent, making manual operations inadequate for modern requirements. The advancement of image processing-based target detection and localization technologies, combined with developments in micro-manipulation control theory, has significantly enhanced automation levels in micro-manipulation. In the pick-and-release process, accurate identification and positioning of both the probe tip and the target object are prerequisites for effective manipulation. However, uneven illumination-induced shadows and image noise can substantially affect threshold-based segmentation in micro-manipulation systems, ultimately compromising the accuracy of target recognition and positioning.

Currently, there are two primary approaches to address this issue. The first method employs traditional image processing techniques, designing algorithms to enhance contrast between foreground and background, while using filtering techniques to remove shadows caused by uneven lighting, thereby correcting or mitigating the effects of uneven illumination. The second method leverages deep learning technology, combining powerful hardware resources and large-scale datasets to learn light distribution patterns in images for shadow recognition and correction. While deep learning methods demonstrate strong specificity, simple implementation, and stability, their recognition accuracy depends on the scale and quality of the dataset. Compared to traditional methods, deep learning may achieve higher recognition accuracy but requires substantial data support. Traditional image processing methods, though widely applicable, demand considerable computational time.

Although scholars worldwide have conducted extensive research on micro-manipulation target segmentation, existing algorithms under microscopic vision still suffer from low precision in image processing when affected by factors such as shadows caused by uneven illumination and image noise. Therefore, developing a high-precision and highly robust microscopic vision target segmentation algorithm is crucial for achieving automation in micro-manipulation.

### SUMMARY

The present invention aims to address the low accuracy of existing micro-operation target segmentation methods caused by the influence of shadows due to image noise and uneven illumination. To this end, a micro-operation target segmentation method based on improved Otsu and edge operators is proposed.

The technical solution adopted by the present invention to solve the aforementioned technical problems is: a micro-operation-based target segmentation method based on improved Otsu and edge operators, which specifically comprises the following steps:

Step 1: The original image containing the micro-operation target is converted into a grayscale image, and then the improved bilateral filtering algorithm is used to denoise the grayscale image to obtain the denoised image.

The improved bilateral filtering algorithm specifically improves the weighting coefficients of the grayscale domain. The improved weighting coefficients of the grayscale domain are as follows:

$${ω}_{s} ( x , y ) = exp [ - \frac{{k}_{s} \cdot exp ( \vert f ( x , y ) - f ( {x}_{0} , {y}_{0} ) \vert )}{2 {σ}_{s}^{2}} ]$$

Here, ωₛ(x,y) denotes the grayscale domain weighting coefficient for pixel (x,y), kₛ represents the weight value, and f(x₀,y₀) is a gray scale map Pixel in image (x₀,y₀) gray value.

f(x,y) is the gray value of pixel point (x,y) in the gray image, where denotes absolute value calculation. (x,y)∈M(x₀,y₀), where M(x₀,y₀) is the set of pixels within the convolution kernel centered at (x₀,y₀). The standard deviation of the grayscale domain is denoted as σₛ.

If the number of segmented targets in the micro-operation target segmentation result is consistent with the actual number of micro-operation targets in the original image, the obtained micro-operation target segmentation result is directly taken as the final micro-operation target segmentation result;

If the number of targets separated in the micro-operation target segmentation result is inconsistent with the actual number of micro-operation targets in the original image, then step 3 is executed on the denoised image;

Step 3: Perform micro-operation target segmentation on the denoised image using the enhanced edge operator and Otsu algorithm to obtain the final segmented result.

The beneficial effects of the present invention are:
1. The enhanced bilateral filtering in this invention demonstrates significantly improved noise reduction, resulting in smoother image pixel values. By reducing the convolution kernel weights at edge locations, the filtered edge information is preserved more intact. Compared to the original bilateral filtering algorithm, the improved version achieves better filtering performance and edge preservation effects.
2. The improved Otsu threshold segmentation algorithm obtains relatively stable thresholds, which are basically not affected by the ratio of foreground and background pixels, and can accurately separate foreground and background to ensure the accuracy of segmentation.
3. The method of the present invention removes the shadows around the image, obtains a more accurate foreground target and contour range, is more conducive to improving the accuracy of subsequent micro-operation target recognition and positioning, and has strong adaptability to changes in the external environment.

### BRIEF DESCRIPTION OF THE DRAWINGS

FIG. 1 is a flowchart of a micro-operation-based object segmentation method based on improved Otsu and edge operators;

FIG. 2 illustrates the workflow for target segmentation on denoised images using the enhanced edge operator and Otsu algorithm.

### DETAILED DESCRIPTION OF THE EMBODIMENTS

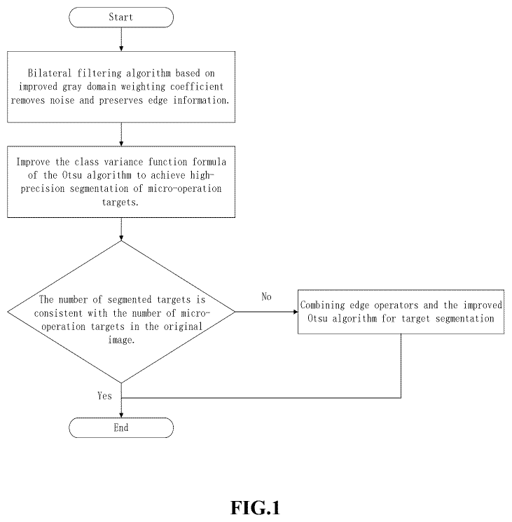

Specific Implementation Method 1: This method is illustrated with reference to FIG. 1. The proposed micro-operation-based object segmentation method, which improves Otsu and edge operators, comprises the following steps:

Step 1: The original image containing the micro-operation target is converted into a grayscale image, and then the improved bilateral filtering algorithm is used to denoise the grayscale image to obtain the denoised image;

The enhanced bilateral filtering algorithm specifically improves the grayscale domain weighting coefficients by replacing the original grayscale difference parameter f(x,y)−f(x₀,y₀) in ωₛ(x,y) with an exponential parameter exp(|f(x,y)−f(x₀,y₀)|), thereby amplifying the grayscale difference. The refined weighting coefficients are defined as:

$${ω}_{s} ( x , y ) = exp [ - \frac{{k}_{s} \cdot exp ( \vert f ( x , y ) - f ( {x}_{0} , {y}_{0} ) \vert )}{2 {σ}_{s}^{2}} ]$$

Here, ωₛ(x,y) denotes the grayscale domain weighting coefficient for pixel (x,y), where kₛ is the weight value. f(x₀,y₀) and f(x,y) represent the grayscale values of pixels (x,y) and (x₀,y₀) in the grayscale image, respectively. The absolute value |-| indicates the calculation of absolute value. (x,y)∈M(x₀,y₀), where M(x₀,y₀) is the convolution kernel centered at the pixel (x₀,y₀) in the grayscale image (as described in this paper). The convolution kernel size used in the model is 3×3 pixels. σₛ represents the standard deviation of the grayscale domain, calculated by taking the difference between the grayscale values of each pixel in set M(x₀,y₀) and the corresponding pixel (x,y), and then computing the standard deviation of all these differences.

Step 2: Perform micro-operation target segmentation on the denoised image using the improved Otsu algorithm to obtain the segmented results;

If the number of segmented targets in the micro-operation target segmentation result is consistent with the actual number of micro-operation targets in the original image, the obtained micro-operation target segmentation result is directly taken as the final micro-operation target segmentation result;

If the number of segmented targets in the micro-operation target segmentation result is inconsistent with the actual number of micro-operation targets in the original image, then step 3 is executed on the denoised image;

Step 3: Perform micro-operation target segmentation on the denoised image using the enhanced edge operator and Otsu algorithm to obtain the final segmented result.

Uneven illumination causes shadows to form along image edges. Since the dark values in foreground areas and edge regions share similar pixel intensities, image segmentation often misidentifies foreground elements as shadows. This phenomenon becomes particularly pronounced when the tool occupies a small portion of the image. To address this issue, the present invention employs the method described in Step 3 to eliminate the impact of these shadows on target recognition.

Specific implementation mode 2: The difference between the specific implementation mode 2 and the specific implementation mode 1 is that the specific process of using the improved bilateral filtering algorithm to denoise the grayscale image is as follows

$${f}_{Bilateral} ( {x}_{0} , {y}_{0} ) = \frac{{\sum }_{( x , y ) ∈ M ( {x}_{0} , {y}_{0} )} ω ( x , y ) f ( x , y )}{{\sum }_{( x , y ) ∈ M ( {x}_{0} , {y}_{0} )} ω ( x , y )}$$

Here, f_{Bilateral} (x₀,y₀) denotes the grayscale value of pixel (x₀,y₀) in the denoised image, while ω(x,y) represents the bilateral filtering weight function for pixel (x,y) in the original image.

$$ω ( x , y ) = {ω}_{d} ( x , y ) \cdot {ω}_{s} ( x , y )$$

Here, ω_{d}(x,y) is the spatial distance field weighting coefficient for pixel (x,y).

Other steps and parameters are the same as the specific embodiment 1. ω_{d}(x,y) represents Gaussian filtering, primarily used to blur pixels. ωₛ(x,y) employs grayscale differences as Gaussian parameters to calculate weights, where larger differences correspond to smaller weights. By multiplying these two components, the system reduces edge sensitivity during image processing through proportionally decreasing weights at edges. This invention utilizes an improved bilateral filtering algorithm for denoising, which not only enhances noise reduction effectiveness but also achieves smoother pixel values. The reduced convolution kernel weights at edge locations preserve more complete edge information, addressing the limitations of traditional bilateral filtering algorithms that suffer from blurred edges and fail to meet precision requirements for micro-operation target recognition and localization.

Specific implementation mode 3: The difference between the present implementation mode and the specific implementation mode 1 or 2 is that the spatial distance field weighting coefficient ω_{d}(x,y) of the pixel point (x,y) is:

$${ω}_{d} ( x , y ) = exp [ - \frac{{k}_{s} \cdot exp ( \vert f ( x , y ) - f ( {x}_{0} , {y}_{0} ) \vert )}{2 {σ}_{s}^{2}} ]$$

Here, σ_{d} denotes the standard deviation in the spatial domain.

Other steps and parameters are the same as those of specific embodiments 1 or 2.

For each pixel in set M(x₀,y₀), all pixels are computed \sqrt{(x−x₀)²+(y−y₀)²} again.

The standard \sqrt{(x−x₀)²+(y−y₀)²} deviation corresponding to the point will be used as the standard deviation for the spatial domain.

Specific implementation mode 4: The difference between the present mode and any one of the specific implementation modes 1 to 3 is that the calculation method of the weight value kₛ is as follows:
The x-directional Robert operator ∇fₓ and y-directional Robert operator ∇f_{y} are defined as:

$$∇ {f}_{x} = [ \begin{matrix}- 1 & 0 \\ 0 & 1\end{matrix} ]$$

$$∇ {f}_{y} = [ \begin{matrix}0 & - 1 \\ 1 & 0\end{matrix} ]$$

The gradient image of the original image is constructed using ∇fₓ and ∇f_{y}. The average grayscale value k of all pixels in the gradient image is then calculated, and the weight value kₛ is subsequently determined using k:

$${k}_{s} = {log}_{k} [ \vert f ( x , y ) - f ( {x}_{0} , {y}_{0} ) \vert + 1 ]$$

Other steps and parameters are the same as those in one of the specific embodiments from one to three.

Substituting the weight value kₛ into the improved grayscale domain weighting coefficient yields:

$${ω}_{s} ( x , y ) = exp [ - \frac{{log}_{k} [ \vert f ( x , y ) - f ( {x}_{0} , {y}_{0} ) \vert + 1 ] \cdot exp [ \vert f ( x , y ) - f ( {x}_{0} , {y}_{0} ) \vert ]}{2 {σ}_{s}^{2}} ]$$

The present invention adds a weight value kₛ to the modified gray difference index. When the gray difference is low, the gray field weighting coefficient can be appropriately increased to protect the filtering effect of low gray difference.

Specific Implementation Mode 5: This mode differs from any of the first to fourth modes in that it performs micro-operation target segmentation on the denoised image using the improved Otsu algorithm, specifically:

Step 2-1: Calculate the total number of pixels N and the average grayscale value μ of all pixels in the denoised image.

$$N = {\sum }_{i = 0}^{255} {n}_{i}$$

$$μ = \frac{{\sum }_{i = 0}^{255} i \cdot {n}_{i}}{N}$$

Here, nᵢ denotes the number of pixels with gray-level value i in the denoised image;

Calculate the proportion of pixels corresponding to each grayscale value in the total number of pixels N:

$${P}_{i} = \frac{{n}_{i}}{N}$$

Here, Pᵢ denotes the proportion of pixels with gray value i out of the total number of pixels;

Step 22: Establish the inter-class variance function σ based on Pᵢ:

$$σ = ln ( {ω}_{0} {ω}_{1} + 1 ) \cdot exp ( \vert {μ}_{0} - {μ}_{1} \vert ) \cdot \vert {μ}_{0} - {μ}_{1} \vert$$

Here, μ₀ represents the expected grayscale value of the foreground, μᵢ represents the expected grayscale value of the background, ω₀ denotes the sum of grayscale probabilities of the background, and ωᵢ denotes the sum of grayscale probabilities of the foreground.

$${μ}_{0} = \frac{{\sum }_{i = 0}^{T} {ip}_{i}}{{ω}_{0}} ,$$

$${ω}_{0} = {\sum }_{i = T + 1}^{255} {p}_{i}$$

$${μ}_{1} = \frac{{\sum }_{i = T + 1}^{255} {ip}_{i}}{{ω}_{1}} ,$$

$${ω}_{1} = {\sum }_{i = 0}^{T} {p}_{i}$$

where T is the segmentation threshold;

In step 2-3, the segmentation threshold is obtained to maximize the value of the inter-class variance function, and the pixels whose grayscale value is greater than or equal to the segmentation threshold are divided into the foreground, and the pixels whose grayscale value is less than the segmentation threshold are divided into the background.

Other steps and parameters are the same as those in any of the specific embodiments from one to four.

When there is a significant disparity in data volume between foreground and background in images, the traditional Otsu algorithm using the maximum inter-class variance method tends to set thresholds that favor the background. This often results in false foreground detection of background areas, leading to suboptimal segmentation accuracy. To enhance the precision of Otsu algorithm segmentation, this invention improves the inter-class variance function by applying logarithmic weighting to the data ratio product in the variance formula using natural logarithmic constants, while simultaneously enhancing the average grayscale difference component through exponential weighting. These modifications ensure the improved Otsu threshold segmentation algorithm achieves relatively stable thresholds that remain unaffected by foreground-background pixel ratio variations, thereby enabling accurate foreground-background separation.

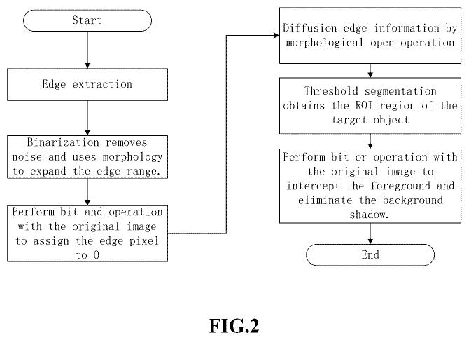

Specific implementation mode 6: The present mode of implementation is described with reference to FIG. 2. The present mode of implementation differs from any of the specific implementation modes 1 to 5 in that the specific process of step 3 is as follows:

Step 3-1: Establish the first edge detection operator and the second edge detection operator separately. The first operator convolves with the denoised image to obtain edge gradient image I₁, while the second operator convolves with the denoised image to obtain edge gradient image I₂.

The edge gradient image I₁ is combined with the grayscale values of corresponding pixels in the edge gradient image I₂ to produce the final edge gradient image I.

Step 3-2: The enhanced Otsu algorithm is applied to perform threshold segmentation on the edge gradient image I (to eliminate noise generated during gradient edge detection). Subsequently, the edge information in the threshold segmentation results is enhanced through morphological opening operation, yielding a binary image with diffused edge details.

Step 33: Perform an AND operation between the binary image with expanded edge information and the denoised image, specifically:

For any pixel in the denoised image, if the corresponding pixel in the expanded edge information binary image is foreground, its grayscale value remains unchanged in the denoised image. If the corresponding pixel is background, its grayscale value is set to 0. After processing each pixel in the denoised image, the resulting image A is obtained.

The black grayscale values of the foreground object's edge in image A are diffused inward to obtain the region where the foreground object is located;

Step 3-4: Remove the foreground object region from image A to obtain residual image B. Then, apply the improved Otsu algorithm to perform threshold segmentation on residual image B, yielding binary image C corresponding to it. Finally, perform an OR operation between binary image C and the denoised image (which preserves foreground information while eliminating background shadows).

The specific process of the bit or operation is as follows:

For any pixel in binary image C, if it is a background pixel, the corresponding pixel's grayscale value in the denoised image remains unchanged; if it is a foreground pixel, the denoise the grayscale value of the corresponding pixel is set to 255. After processing the denoised image, the adjusted pixel values are obtained. After the denoising process, the resulting image D (since the foreground object area has been removed from the residual image B, some pixels in the denoised image do not correspond to any pixels in the remaining image C. Consequently, the grayscale values of these pixels remain unchanged in image D. As these pixels will be removed in subsequent processing steps, they will not affect the final result).

The image E (the image with shadow elimination) is formed by combining all pixels corresponding to the binary image C in the image D;

Step 35: Apply the enhanced Otsu algorithm to segment image E, identifying its foreground region. This foreground region, combined with the foreground object area obtained in Step 33, constitutes the micro-operation target area.

Other steps and parameters are the same as those in one of the specific embodiments from one to five.

The invention employs an enhanced edge operator to correct shadows caused by uneven illumination. After removing peripheral shadows, the image undergoes threshold segmentation using the improved Otsu algorithm, which yields more precise foreground target and contour boundaries. This approach is crucial for achieving high-precision automatic recognition and positioning of micro-operation targets.

Specific Implementation Mode 7: This mode differs from any of the first to sixth specific implementation modes in that the first. The second edge detection operator is

$$( \begin{matrix}- 1 & 2 & 3 & 2 & - 1 \\ 2 & 0 & - 1 & 0 & - 2 \\ 3 & - 1 & 8 & - 1 & - 3 \\ 2 & 0 & - 1 & 0 & - 2 \\ - 1 & - 2 & - 3 & - 2 & - 1\end{matrix} ) ,$$

$$The second edge detection operator is ( \begin{matrix}- 1 & - 2 & - 3 & - 2 & - 1 \\ - 2 & 0 & - 1 & 0 & 2 \\ - 3 & - 1 & 8 & - 1 & 3 \\ - 2 & 0 & - 1 & 0 & 2 \\ - 1 & 2 & 3 & - 2 & - 1\end{matrix} ) .$$

Other steps and parameters are the same as those in any of the specific embodiments from one to six.

The Laplacian operator, as a second-order derivative edge detection tool, excels in detail sensitivity with high precision and directionality independence, offering rapid response. However, it remains noise-sensitive. The Sobel operator, on the other hand, calculates gradient magnitudes between pixels using first-order derivatives and incorporates Gaussian formula-based operator weights. This design effectively highlights edge features while suppressing image noise. To balance speed and accuracy in edge detection, we developed a diagonal first-edge detection operator and a second-edge detection operator by combining Sobel and Laplacian techniques.

### Examples

This embodiment proposes a micro-operation-based object segmentation method based on improved Otsu and edge operators, which specifically includes the following steps:

Step 1: The original image containing micro-operation targets is first converted to grayscale to obtain a grayscale image. Then, an improved bilateral filtering algorithm is applied to denoise the grayscale image, resulting in a denoised image. Specifically:

$${f}_{Bilateral} ( {x}_{0} , {y}_{0} ) = \frac{{\sum }_{( x , y ) ∈ M ( {x}_{0} , {y}_{0} )} ω ( x , y ) f ( x , y )}{{\sum }_{( x , y ) ∈ M ( {x}_{0} , {y}_{0} )} ω ( x , y )}$$

Here, the f_{Bilateral}(x₀,y₀) gray-level value of pixel (x₀,y₀) in the denoised image is represent-ted by ω(x,y), which is the bilateral filter weight function for pixel (x,y) in the original image.

$$ω ( x , y ) = {ω}_{d} ( x , y ) \cdot {ω}_{s} ( x , y )$$

Here, ω_{d}(x,y) is the spatial distance field weighting coefficient for pixel (x,y).

The spatial distance domain weighting coefficient ω_{d}(x,y) for pixel points (x,y) is:

$${ω}_{d} ( x , y ) = exp [ - \frac{{( x - {x}_{0} )}^{2} - {( y - {y}_{0} )}^{2}}{2 {σ}_{d}^{2}} ]$$

Here, σ_{d} denotes the standard deviation in the spatial domain.

The original ωₛ(x,y) grayscale difference parameter f(x,y)−f(x₀,y₀) is replaced with the grayscale difference index parameter exp(|f(x,y)−f(x₀,y₀)|) to enhance the grayscale difference value. The modified grayscale domain weighting coefficient is specified as:

$${ω}_{s} ( x , y ) = exp [ - \frac{{k}_{s} \cdot exp ( \vert f ( x , y ) - f ( {x}_{0} , {y}_{0} ) \vert )}{2 {σ}_{s}^{2}} ]$$

Here, ωₛ(x,y) denotes the grayscale domain weighting coefficient for pixel (x,y), where kₛ is the weight value. f(x₀,y₀) and f(x,y) represent the grayscale values of pixels (x,y) and (x₀,y₀) in the grayscale image, respectively. The absolute value |⋅| indicates the calculation of absolute value. (x,y)∈M(x₀,y₀), where M(x₀,y₀) is the convolution kernel centered at the pixel (x₀,y₀) in the grayscale image (as described in this paper). The convolution kernel size used in the model is 3×3 pixels. σₛ represents the standard deviation of the grayscale domain, calculated by taking the difference between the grayscale values of each pixel in set M(x₀,y₀) and the corresponding pixel (x,y), and then computing the standard deviation of all these differences, and kₛ is the weight value.

The calculation method of the weight value kₛ is as follows:

The x-directional Robert operator ∇fₓ and y-directional Robert operator ∇f_{y} are defined as:

$$∇ {f}_{x} = [ \begin{matrix}- 1 & 0 \\ 0 & 1\end{matrix} ]$$

$$∇ {f}_{y} = [ \begin{matrix}0 & - 1 \\ 1 & 0\end{matrix} ]$$

The gradient image of the original image is constructed using ∇fₓ and ∇f_{y} The average grayscale value k of all pixels in the gradient image is then calculated, and the weight value kₛ is computed using k:

$${k}_{s} = {log}_{k} [ \vert f ( x , y ) - f ( {x}_{0} , {y}_{0} ) \vert + 1 ]$$

Step 2: Perform micro-operation target segmentation on the denoised image using the improved Otsu algorithm to obtain the segmented results. Specifically:

Step 2-1: Calculate the total number of pixels N and the average grayscale value p of all pixels in the denoised image.

$$μ = \frac{{\sum }_{i = 0}^{255} i \cdot {n}_{i}}{N}$$

$$N = {\sum }_{i = 0}^{255} {n}_{i}$$

Here, nᵢ denotes the number of pixels with gray-level value i in the denoised image;

Calculate the proportion of pixels corresponding to each grayscale value in the total number of pixels N:

$${p}_{i} = \frac{{n}_{i}}{N}$$

Here, pᵢ denotes the proportion of pixels with gray value i out of the total number of pixels;

Step 2-2: Establish the inter-class variance function σ based on pᵢ:

$$σ = ln ( {ω}_{0} {ω}_{1} + 1 ) \cdot exp ( {μ}_{0} {μ}_{1} ) \cdot \vert {μ}_{0} - {μ}_{1} \vert$$

Here, μ₀ represents the expected grayscale value of the foreground, A represents the expected grayscale value of the background, and ω₀ denotes the probability of the background's grayscale value-and, ω₁ is the sum of the probability values of the foreground grayscale;

$${μ}_{0} = \frac{{\sum }_{i = 0}^{T} , {ip}_{i}}{{ω}_{0}} , {ω}_{0} = {\sum }_{i = T + 1}^{255} {p}_{i} \\ {μ}_{1} = \frac{{\sum }_{i = T + 1}^{255} {ip}_{i}}{{ω}_{1}} , {ω}_{1} = {\sum }_{i = 0}^{T} {p}_{i}$$

where T is the segmentation threshold;

In step 2 and 3, the segmentation threshold is obtained to maximize the value of the inter-class variance function, and the pixels whose grayscale value is greater than or equal to the segmentation threshold are divided into the foreground, and the pixels whose grayscale value is less than the segmentation threshold are divided into the background.

If the number of segmented targets in the micro-operation target segmentation result is consistent with the actual number of micro-operation targets in the original image, the obtained micro-operation target segmentation result is directly taken as the final micro-operation target segmentation result;

If the number of targets separated in the micro-operation target segmentation result is inconsistent with the actual number of micro-operation targets in the original image, then step 3 is executed on the denoised image;

Step 3: Perform micro-operation target segmentation on the denoised image using the enhanced edge operator and Otsu algorithm to obtain the final segmented result. Specifically:

Step 3-1: Establish the first edge detection operator and the second edge detection operator respectively:

$$( \begin{matrix}- 1 & 2 & 3 & 2 & - 1 \\ 2 & 0 & - 1 & 0 & - 2 \\ 3 & - 1 & 8 & - 1 & - 3 \\ 2 & 0 & - 1 & 0 & - 2 \\ - 1 & - 2 & - 3 & - 2 & - 1\end{matrix} ) \\ ( \begin{matrix}- 1 & - 2 & - 3 & - 2 & - 1 \\ - 2 & 0 & - 1 & 0 & 2 \\ - 3 & - 1 & 8 & - 1 & 3 \\ - 2 & 0 & - 1 & 0 & 2 \\ - 1 & 2 & 3 & - 2 & - 1\end{matrix} )$$

The first edge detection operator is convolved with the denoised image to obtain edge gradient image I₁, and the second edge detection operator is convolved with the denoised image to obtain edge gradient image I₂.

The edge gradient image I₁ is combined with the grayscale values of corresponding pixels in the edge gradient image I₂ to produce the final edge gradient image I.

Step 3-2: The enhanced Otsu algorithm is applied to perform threshold segmentation on the edge gradient image I (to eliminate noise generated during gradient edge detection). Subsequently, the edge information in the threshold segmentation results is enhanced through morphological opening operation, yielding a binary image with diffused edge details.

Step 3-3: Perform an AND operation between the binary image with expanded edge information and the denoised image, specifically:

For any pixel in the denoised image, if the corresponding pixel in the edge-enhanced binary image is foreground, its grayscale value remains unchanged in the denoised image. If the corresponding pixel in the edge-enhanced binary image is background, the grayscale value is adjusted accordingly in the denoised image. Set the grayscale value of each pixel to 0; after processing each pixel in the denoised image, obtain image A.

The black grayscale values of the foreground object's edge in image A are diffused inward to obtain the region where the foreground object is located;

Step 3-4: Remove the foreground object region from image A to obtain residual image B. Then apply the improved Otsu algorithm to perform threshold segmentation on residual image B, yielding binary image C corresponding to it. Finally, perform an OR operation between binary image C and the denoised image (which preserves foreground information while eliminating background shadows).

The specific process of the bit or operation is as follows:

For any pixel in binary image C, if it is a background pixel, its grayscale value in the denoised image remains unchanged. If it is a foreground pixel, its grayscale value in the denoised image is set to 255. After processing each pixel in the denoised image, the adjusted denoised image D is obtained. Since the remaining image B has already removed the foreground object area, some pixels in the denoised image do not correspond to any pixels in the original image C. Therefore, the grayscale values of these pixels remain unchanged in image D. As these pixels will be removed in subsequent processing steps, they will not affect the final result.

The image E (the image with shadow elimination) is formed by combining all pixels corresponding to the binary image C in the image D;

Step 3-5: Apply the enhanced Otsu algorithm to segment image E, identifying its foreground region. This foreground region, combined with the foreground object area obtained in Step 3-3, constitutes the micro-operation target area.

The examples provided in this invention are intended solely to illustrate the computational model and workflow in detail, rather than limiting the implementation methods. Skilled professionals in the field may make various modifications or variations based on these explanations. As exhaustive enumeration of all possible implementations is impractical, any obvious modifications or adaptations derived from the technical solutions herein shall remain within the scope of protection of this invention.

What is claimed is:

1. A micro-operation-based object segmentation method based on improved Otsu and edge operators, comprising the following steps:
Step 1: processing an original image containing micro-operation target is gray-scale to obtain a gray-scale image, and then using an improved bilateral filtering algorithm to denoise the gray-scale image to obtain the denoised image;
Wherein the improved bilateral filtering algorithm specifically improves the weighting coefficients in the grayscale domain; wherein the improved weighting coefficients in the grayscale domain are as follows:
$${ω}_{s} ( x , y ) = exp [ - \frac{{k}_{s} \cdot exp ( f ( x , y ) - f ( {x}_{0} , {y}_{0} ) )}{2 {σ}_{s}^{2}} ]$$
Where represents the grayscale domain represents a weighting coefficient for pixel, where the weight value is the grayscale value of pixel in the grayscale image, and the grayscale value of pixel (3) is the corresponding value denotes the absolute value calculation, where is the set of pixels within the convolution kernel centered at pixel in the grayscale image, and is the standard deviation of the grayscale domain
The specific process of denoising the original image containing micro-operation targets by using the improved bilateral filtering algorithm is as follows:
$${f}_{Bilateral} ( {x}_{0} , {y}_{0} ) = \frac{{\sum }_{( x , y ) ∈ M ( {x}_{0} , {y}_{0} )} ω ( x , y ) f ( x , y )}{{\sum }_{( x , y ) ∈ M ( {x}_{0} , {y}_{0} )} ω ( x , y )}$$
Here, the f_{Bilateral} (x₀,y₀) gray-level value of pixel (x₀,y₀) in the denoised image is represent-ted by ω(x,y), which is the bilateral filter weight function for pixel (x,y) in the original image;
$$ω ( x , y ) = {ω}_{d} ( x , y ) \cdot {ω}_{s} ( x , y )$$
Here, ω_{d}(x,y) denotes the spatial distance domain weighting coefficient for pixel (x,y);
$${ω}_{d} ( x , y ) = exp [ - \frac{{( x - {x}_{0} )}^{2} + {( y - {y}_{0} )}^{2}}{2 {σ}_{d}^{2}} ]$$
Where σ_{d} is the standard deviation of the spatial domain;
The weight kₛ value is calculated as follows:
The x-direction and y-direction ∇fₓ Robert operators are defined ∇f_{y} as:
$$∇ {f}_{x} = [ \begin{matrix}- 1 & 0 \\ 0 & 1\end{matrix} ] \\ ∇ {f}_{y} = [ \begin{matrix}0 & - 1 \\ 1 & 0\end{matrix} ]$$
Calculate ∇fₓ and ∇f_{y}, average grayscale value of all pixels in the gradient image by utilizing k and constructing the original image; Recalculate k the weight kₛ values:
$${k}_{s} = {log}_{k} [ \vert f ( x , y ) - f ( {x}_{0} , {y}_{0} ) \vert + 1 ]$$
Step 2: Micro-operation target segmentation is performed on the denoised image based on the improved Otsu algorithm to obtain micro-operation target segmentation results;
If the number of segmented targets in the micro-operation target segmentation result is consistent with the actual number of micro-operation targets in the original image, the obtained micro-operation target segmentation result is directly taken as the final micro-operation target segmentation result;
If the number of segmented targets in the micro-operation target segmentation result is inconsistent with the actual number of micro-operation targets in the original image, then step 3 is executed on the denoised image;
Step 3: Using the enhanced edge operator and Otsu algorithm, perform micro-operation target segmentation on the denoised image to obtain the final segmented result.

2. A micro-operation target segmentation method based on improved Otsu and edge operators as claimed in claim 1, characterized in that the improved Otsu algorithm performs micro-operation target segmentation on the denoised image, specifically:
Step 2-1: Calculate the total number of pixels in the denoised N image and the average u gray value of all pixels:
$$N = {\sum }_{i = 0}^{255} {n}_{i} \\ μ = \frac{{\sum }_{i = 0}^{255} i \cdot {n}_{i}}{N}$$
Where represents nᵢ the number of pixels with a i given grayscale value in the denoised image;
The proportion of pixels N corresponding to each grayscale value is calculated as follows:
$${p}_{i} = \frac{{n}_{i}}{N}$$
Where represents pᵢ the proportion i of pixels with gray-level values to the total number of pixels;
Step 2-2: Establish the between-class variance function σ from pᵢ;
$$σ = ln ( {ω}_{0} {ω}_{1} + 1 ) \cdot exp ( \vert {μ}_{0} - {μ}_{1} \vert )$$
Where the expected μ₀ grayscale value of p the foreground, ω₀ the expected grayscale value of the background, and the sum of the grayscale probabilities of the background are respectively; ω₁ the sum of the probabilities of the grayscale values in the foreground;
$${μ}_{0} = \frac{{\sum }_{i = 0}^{T} {ip}_{i}}{{ω}_{0}} , {ω}_{0} = {\sum }_{i = T + 1}^{255} {p}_{i} \\ {μ}_{1} = \frac{{\sum }_{i = T + 1}^{255} {ip}_{i}}{{ω}_{1}} , {ω}_{1} = {\sum }_{i = 0}^{T} {p}_{i}$$
Where is T the segmentation threshold;
Step 2-3: Obtain the segmentation threshold that makes the value of the inter-class variance function reach the maximum; Divide the pixels whose grayscale value is greater than or equal to the segmentation threshold into the foreground and divide the pixels whose grayscale value is less than the segmentation threshold into the background.

3. The micro-operation-based object segmentation method based on improved Otsu and edge opera-tors as claimed in claim 2, wherein the specific process of step 3 is:
Step 3-1: Establish the first edge detection operator and the second edge detection operator separately; The first operator convolves with the denoised I₁ image to obtain the edge gradient image, while the second operator processes the denoised image; The edge gradient image is obtained I₂ by image convolution;
Add the edge gradient I₁ image to the corresponding I₂ pixel gray value in the edge gradient image I to obtain the edge gradient image;
Step 3-2: The enhanced Otsu algorithm is applied to perform I threshold segmentation on edge gradient images; By employing the opening operation in morphological processing, the edge information in the segmented results is enhanced, ultimately yielding a binary image with diffused edge details;
Step 3-3: Perform an AND operation between the binary image with expanded edge information and the denoised image, as follows:
For any pixel in the denoised image, if its corresponding pixel in the expanded edge information binary image is foreground, the grayscale value remains unchanged; if it is background, the grayscale value is set to 0; After processing each pixel individually, the resulting image is denoised image A;
Diffuse the black grayscale value of the foreground object edge in image A to the inside to obtain the region where the foreground object is located;
Step 3-4: Extract the foreground object region from Image A to obtain the residual image B; Then, apply the improved Otsu algorithm to perform threshold segmentation on the residual image B, yielding the binary image C corresponding to it; Finally, perform an OR operation between the binary image C and the denoised image;
The bit OR operation is performed as follows:
For any pixel in binary image C: if it is background, its grayscale value remains unchanged in the denoised image; if it is foreground, its grayscale value is set to 255. After processing each pixel in the denoised image separately, the adjusted denoised image D is obtained;
Image E is formed by combining all pixels corresponding to binary image C in image D;
Step 3-5: Apply the enhanced Otsu algorithm to segment image E, identifying its foreground region; This foreground region, combined with the foreground object area from Step 3-3, forms the micro-operation target area.

4. A micro-operation-based target segmentation method based on improved Otsu and edge operators as claimed in claim 3, characterized by the key difference lies in the fact that the first edge detection operator is
$$( \begin{matrix}- 1 & 2 & 3 & 2 & - 1 \\ 2 & 0 & - 1 & 0 & - 2 \\ 3 & - 1 & 8 & - 1 & - 3 \\ 2 & 0 & - 1 & 0 & - 2 \\ - 1 & - 2 & - 3 & - 2 & - 1\end{matrix} ) ,$$
and the second edge detection operator is
$$( \begin{matrix}- 1 & - 2 & - 3 & - 2 & - 1 \\ - 2 & 0 & - 1 & 0 & 2 \\ - 3 & - 1 & 8 & - 1 & 3 \\ - 2 & 0 & - 1 & 0 & 2 \\ - 1 & 2 & 3 & - 2 & - 1\end{matrix} )$$
